(19) United States
(12) Patent Application Publication
(10) Pub. No.: US 2019/0387735 A1
(43) Pub. Date: Dec. 26, 2019

(54) Wireless Wildlife Observation Intelligence System

(71) Applicant: Swift Info Outdoor Products, Fremont, CA (US)

(72) Inventors: Ernest Wynn, Mountain Home, TX (US); Lei Shi, Tullahoma, TN (US)

(73) Assignee: Swift Info Outdoor Products, Fremont, CA (US)

(21) Appl. No.: 16/451,886

(22) Filed: Jun. 25, 2019

Related U.S. Application Data
(60) Provisional application No. 62/689,377, filed on Jun. 25, 2018.

(51) Int. Cl. A01M 31/00; A01K 5/02; H04W 4/38; H04L 29/06

(52) U.S. Cl. CPC A01M 31/002; A01K 5/02; H04L 65/4069; H04W 4/38; A01M 31/008

(57) ABSTRACT

A wireless wildlife observation intelligence system includes a timer including intelligent manageability software; data collection hub including a camera and temperature sensor, wirelessly connected at least one of a cloud based-system or user; an antenna; a mobile app; a solar panel; a rechargeable battery; a feed hopper including a feed level indicator; an access point range extender; and a motor operatively connected to the timer and feed hopper and a method for wireless wildlife observation, using the system for capturing still and video data along with metadata values of: date, time, moon phase, gps coordinates, location name, temperature, and weather conditions to create reporting and algorithms which trigger actions/send commands to other connected devices; and performing at least one of automatically adjusting the scheduled feed dispersion times of a timer based on the natural times when animals come to the feed location as well as report optimal visit times that are specific to that location's environment.

### CROSS REFERENCE

This application claims the benefit of the filing date of U.S. Provisional Patent Application Ser. No. 62/689377, filed Jun. 25, 2018, which is hereby incorporated by reference in its entirety.

### FIELD

The present disclosure relates to a comprehensive data collection and data-action based solution for use in patterning, conditioning, observation and/or attracting of wildlife.

### BACKGROUND

In the current industry, there are a variety of standalone products which aid hunters with the ability to be more successful in observing and/or attracting animals to a hunting location including feeder timers, feed level indicators and trail/observation cameras. Each of these tools, in their current state, act independently, require significant manual interaction and provide no analysis tools to help the user make informed decisions.

Timed delivery of feed (dried corn and protein), has been a popular way to condition wildlife for many years. Essentially, a hopper filled with feed contains a delivery system that incorporates a timer device. The typical timer device is powered by a 6v or 12v lead acid battery and allows the user to create a timed feeding schedule. There are limitations with the current design technology as noted below. To determine if the feeder is functioning properly (verify that the motor is not jammed, verify that the solar panel is charging, verify that the battery is maintaining a charge), the user must physically walk to the deer feeder, open a control panel and then manually adjust and/or test the timer. By physically entering the feeding location, the user spreads human scent and disturbs the area in which they are attempting to attract wildlife. Additionally, administering the device requires the physical opening and administering of test throws of feed. This can be hazardous due to the velocity of the feed being dispensed from the hopper. The typical application includes the installation of a small solar panel to help maintain a charge on the battery. The solar panels in today's current technology are connected directly to the battery and have no charge management features to prevent overcharge of the battery. The current timer technology has no features beyond allowing for timed feeding such as reducing the amount of feed disbursed if the feed hopper is low on feed, the ability to selectively feed by user-defined species when a specific species of animal or desirable featured species of animal are in the feeding area. Additionally, the current designs cannot communicate with other tools and devices nor allow the user to remotely assess the performance of the feeder, administer changes to the timer remotely nor receive notification of problems with the feeder unit electronically. The art lacks a system that addresses many of these limitations of current timer devices.

Feed Level Indicators provide the level of feed remaining in a feeder hopper. This indicates to the user when to fill the feeder. Current technology includes either a small visible window for visual viewing of the feed level or a mathematical calculation which is incorporated into basic analog feeders. The limitations of a visual “viewing window” are clearly that the user must be in extremely close proximity to the feeder and visually see that the feed level has dropped below the visible viewing window. Additionally, the user can only see that the feed level is either above or below the visible window thereby making this highly unreliable as a method for reading the level of feed. The limitation of the timer calculation is also that the user must visually look at the timer, which is only visible at the feeder, and additionally, the timer requires input from the user as to how much feed was added to the feeder for the calculation to effectively work. Lastly, due to variables including feed size, distance between the hopper and dispersal plate, motor speed and duration of feed, the calculation is subject to highly inaccurate results. In either current option, by physically entering the feeding location, the user spreads human scent and disturbs the area in which they are attempting to attract wildlife thereby reducing the probability of attracting animals. Additionally, the current designs cannot communicate with other tools and devices nor allow the user to remotely assess the feed level of the feeder, automatically, trigger timer feed reductions at low feed levels, calculate refill date, administer changes to the feed level indicator remotely nor receive mobile device reminders to fill or notification of a low feed level with the feeder unit electronically. The art lacks a system that addresses many of these limitations of current feel level indicators.

Current technology consists of stand-alone imaging devices that collect pictures/videos locally to an SD type of card or similar. The user then physically administers the imaging device by removing the card and or viewing the card at the imaging device and then deleting unwanted pictures/saving desired pictures. Additionally, there are imaging devices that connect via cellular data connections which store and display captured pictures/videos on a hosted internet site for the user and sends notifications when activity/pictures are taken. They are limited in that they simply capture and store the pictures and/or videos for the user to view. The current technology stamps the picture with the temperature, time of day, date, moon phase, and weather conditions. The user is required to manually evaluate the time, dates and other relevant indices in which the activity takes place making the process of evaluation of species, frequency of visits, times of the day, weather conditions and other indices used to determine when wildlife is moving cumbersome. Furthermore, the current technology lacks features such as the ability to connect and trigger other devices such as timers and feed level indicators allowing the ability to selectively feed by user-defined species when a specific species of animal or desirable featured species of animal are in the feeding area (selectively feed by species or species attributes). Additionally, the current designs cannot communicate with other tools and devices whereby the user can remotely assess the performance of the feeder, administer changes to the timer, check the feed level remotely nor receive notification of problems with the feeder unit electronically, the ability to receive notification of a species and remotely administer a feeding on demand. Additionally, the current technology does not analyze the data and provide information back to the user relative to the various conditions and times in which animal activity is taking place, nor provided recommendations on when to hunt based upon the captured pictures and videos, nor allow tagging of specific target animals via AI recognition to follow the patterns of a specific animal. The art lacks a system that addresses many of these limitations of current imaging devices.

### SUMMARY

In accordance with one aspect of the present disclosure, there is provided a wireless wildlife observation intelligence system including:
a timer including intelligent manageability software capable of monitoring and managing battery discharge and solar panel battery charging;
a data collection hub including a camera and temperature sensor, wirelessly connected to the timer and at least one of a cloud based-system or user;
an antenna operatively connected to the timer;
a mobile app wirelessly connected to the antenna and capable of operation of the timer;
a solar panel operatively connected to the timer;
a rechargeable battery operatively connected to the timer;
a feed hopper including a feed level indicator capable of dispensing feed;
an access point range extender operatively connected to the system; and
a motor operatively connected to the timer and feed hopper.

In accordance with another aspect of the present disclosure, there is provided a method for wireless wildlife observation, including:
providing a device equipped with one or more sensors, which includes imaging sensors, temperature sensors, humidity sensors, wind speed sensors, distance measurement sensors and gps receivers, wirelessly connected to a locally installed in field data computing and storage device;
capturing still and video data along with metadata values of: date, time, moon phase, gps coordinates, location name, temperature, and weather conditions to create reporting and algorithms which trigger actions/send commands to other connected devices; and
performing at least one of automatically adjusting the scheduled feed dispersion times of a timer based on the natural times when animals come to the feed location as well as report optimal visit times that are specific to that location's environment determined by the collected metadata.

These and other aspects of the present disclosure will become apparent upon a review of the following detailed description and the claims appended thereto.

### BRIEF DESCRIPTION OF THE DRAWINGS

FIG. 1 shows a dynamic report of the scheduled feed times saved to the feeder timer defined by the user vs the actual times when animal activity took place in the past 2 weeks;

FIG. 2 shows a dynamic report with color coded indications of the peak times when there is activity with Red color being no activity to Dark Green being significant activity;

FIG. 3 shows an illustration of the species identification feature selectively feeding only species chosen by the user (in this case DEER), and identified through a species identification image device and algorithm;

FIG. 4 shows an illustration of having a more granular selective feeding definition based on previous setting of DEER and Sex of MALE as identified through a species identification image device and algorithm;

FIG. 5 shows an illustration of various key components that are connected and accessible via mobile device as well as a cellular/satellite connected internet solution;

FIGS. 6A, 6B, 6C, 6D, 6E, 6F, 6G, 6H, and 6I illustrate a sampling of set up screens during product installation instructions and process performed via a mobile device application;

FIG. 7 shows a mobile device application Command Center screen which is the initial screen the user sees when they connect to the devices;

FIG. 8 illustrates the Timer enclosure including the various connection points;

FIG. 9 illustrates the FLI enclosure including features;

FIG. 10A shows an FLI device, FIG. 10B shows a feeder hopper lid and FIG. 10C shows a feeder hopper, illustrating how the FLI works to measure and calculate the linear distance and calculation methodology;

FIG. 11 shows a connectivity diagram of a FLI only installation and connection;

FIG. 12 shows a connectivity diagram of a FLI and a Timer where FLI is paired to Timer installation and connection;

FIG. 13 shows a connectivity diagram of a FLI+Timer+Range Extender installation and connection;

FIG. 14 illustrates a network of Timers and FLIs without using a DCH—connection diagram; and

FIG. 15 shows a system connectivity diagram using a DCH connected via cellular to an internet service/portal.

### DETAILED DESCRIPTION

There are a variety of standalone products which aid hunters with the ability to be more successful in observing and/or attracting animals to a hunting location. These include feeder timers, feed level indicators and trail/observation imaging devices. Each of these tools in their current state, act independently; require significant manual interaction; and provide no analysis tools to help the user make more informed decisions on what is coming to the baited area, such as, when is the most optimal time to hunt, recommending based on collected data trends, the optimal times to feed, the operating condition of the feeder including the feed level, and the ability to administer changes remotely and receive notifications regarding feeder operating condition alerts, including notifications as reminders to fill your feeder, the ability to automatically reduce feed durations to optimize feed yet keep animals conditioned to the location when feed levels are low and the ability to remotely disburse feed from a mobile device or computer with access to the internet. The present system provides the user with key information/updates to allow them to better manage their equipment as well as reporting data decision criteria to the user so they can make more informed decisions and improve the probability of a successful harvest and a post-harvest recovery system/application. Furthermore, each device can operate independently or can be paired to one another to provide flexibility to the user if using a subset of the entire solution. Each device in accordance with the present disclosure, including feed level sensor, timer and imaging sensor with data hub can operate independent of one another and can be paired and connected to expand features. The present devices use wireless connections, such as but not limited to Bluetooth Long Range (BLE 5), Long Range WiFi, Cellular and Satellite. The Software component of the system includes an app for use with mobile devices and PCs as well as an internet/cloud based service allowing the user to send data collected and stored on the local data collection hubs, administer all connected proprietary hunting devices registered to the user and report on one or many hunting locations through software algorithms and reporting features, such as but not limited to: operating efficiencies, feeders needing maintenance, feeders needing filled, animal activity at the observation or feed location, animal profiles, animal pictures and videos. The imaging device connected to the mobile device application software is designed to provide the user with the ability to record in a split video screen of a mobile device using the front or rear facing imaging device of the mobile device in conjunction with the imaging devices and record/live stream a split-screen video for use in self-assessment of shooting discipline or shooter error, playback of a hunt to determine direction of animal to track, creating recreational videos, and streaming live via social media platforms. The post-harvest animal tracking device of the present system leverages wireless connectivity and positioning and collaborative input to create and store a blood trailing map to aid hunters in recovery of a wounded animal. The mobile application provides multiple users the ability to join a collaborative recovery event and drop location identifiers when blood drops are identified. The location identifiers connect the blood drops identified and create a visible blood trail which displays on the screen thereby allowing the retracing of the animal's movement without having to re-identify each drop of blood.

The system is robust and device connection options in accordance with the present disclosure include, but are not limited to the following. The feed level indicator can be used only with wireless connectivity directly to the device (independently). The timer can be used only with wireless connectivity directly to the device (independently). The feed level indicator can pair to the timer for enhanced features and connect to the timer to access both feed level and timer. The data collection hub, including imaging device(s), can be used only with wireless connectivity directly (independently). The data collection hub, including imaging device(s), can be used only connected to a cloud (internet based) access if the user subscribes (require both cellular and internet access). The feed level indicator, timer and data collection hub can pair with an imaging device and access the data collection hub directly via wireless connectivity (directly). The feed level indicator, timer and data collection hub can pair with imaging device and access the data collection hub directly via wireless connectivity and connected to a cloud (internet based) access if the user subscribes (require both cellular and internet access).

The present disclosure includes the following embodiments. A “data collection hub” (DCH) which includes a processor, memory, solar charging with charge management capabilities to charge a DC battery, wireless connectivity including cellular and/or satellite as well as close range connectivity, such as bluetooth and wifi. A mobile application allowing the user to connect directly to the DCH via close ranges of within 400 meters or less direct connection for administration and setup (with optional extended ranges with use of an APRX). The current design also utilizes a user configurable Access Point/Range Extender (APRX) which can be used to extend the range of connection distance as well as configured to act as a access point for creating a standard platform for connection across multiple versions of BLE, thereby providing a predictable and consistent connection range across all mobile devices. Additionally, the APRX can be used to create a closed network of connected devices where the user may have more than one feeder located on a hunting property.

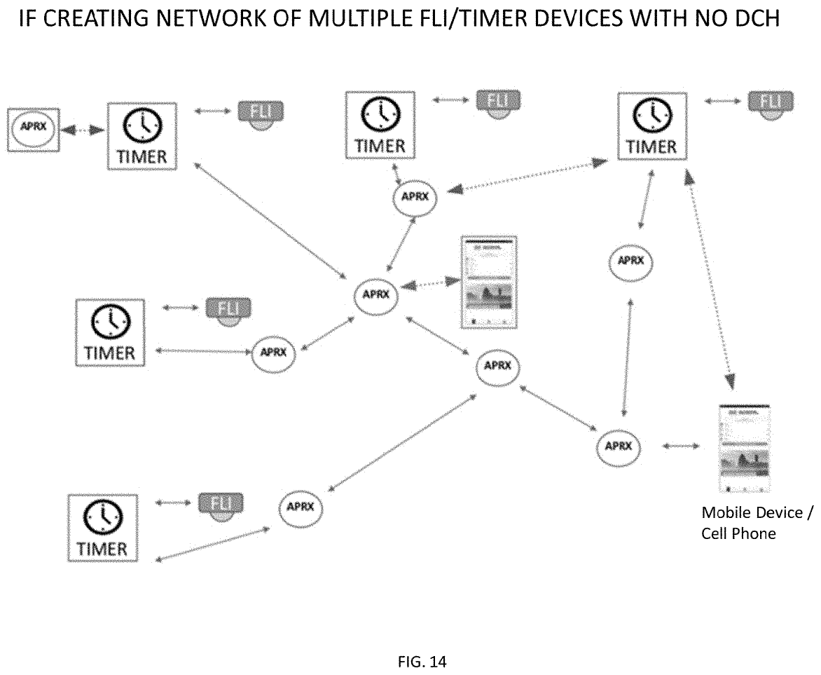

In an embodiment, the present disclosure includes creating a network without DCHs for multiple feeders. A process includes each Timer and FLI connected to one or multiple APRXs. APRXs can be linked together as shown in FIG. 14. The connections between Timer and APRXs, FLI and APRXs, or among APRXs may use BLE long-range mode (coded PHY) to achieve >400 m range with 0 dB TX power. All BLE devices may have options to change TX power. Both BLE Timer and FLI can be connected to mobile phone through one or multiple APRXs. When Timer and FLI are paired together the Timer becomes central, FLI is peripheral and only Timer can be connected to other BLE devices (see red connections in FIG. 14). Mobile phone user when in range of network, whether inside network (green connection) or through multiple APRXs (bottom right), shall see all of the Timers in the network available to connect, e.g., a total of 5 in FIG. 17. Mobile phone user when connected to an APRX, which is not inside the network (top-left purple connection), shall only see the device it is connected to. Push notification from all BLE devices to mobile phone, including battery status and/or other application specific information. Example of push notifications include “Timer #1 is at 25% feed level, remember to fill”, and “Timer #2 is reporting a low battery in the paired FLI”, and “Timer #4 is reporting a jam”, and “Timer #5 is reporting a low battery” and “APRX #8 is reporting 25% battery, please change soon”. Network configuration with app when the user creates a scatter-network, on the settings page, the user has visibility for all connections within the scatter-network allowing the user to change settings (access point vs range extender), and check the battery level and signal strength on one list.

A cloud based internet portal allows the user to access captured data and administer through connected devices located at the observation or feeding area(s).

A wireless, mobile device connected timer can be operated directly from a mobile app through direct connection or it can be paired wirelessly to the data collection hub for expanded features and administered through a cloud based internet portal.

A wireless, mobile device connected to a feed level indicator can be operated directly from a mobile app through direct connection or it can be paired wirelessly to the timer for expanded features including the ability to reduce feed times when feed hopper level reaches 50% or lower.

1 to 4 modular imaging devices wirelessly connected to the data collection hub can be administered locally via direct wireless connection or via cloud account/internet for expanded features including allowing the user to view captured images and videos over an internet connection, view the observation area real-time and administer changes to the observation devices.

The feeder timer of the present disclosure leverages a wireless connection. In addition to providing the user the ability to administer feed dispersion settings via a mobile device, the timer provides on demand feeding and valuable diagnostics relative to the performance of the feeder, such as (but not limited to): battery voltage, solar panel orientation optimization and performance, jam notification and battery charge management. This device can be installed as a standalone product whereby the user installs the product, downloads the mobile app and can take advantage of the enhanced features from distances encompassed in the reasonable range of direct wireless connection technology (approx. 400 meters based upon direct connection wireless technology and without additional APRX devices). The user can install the DCH and a web-based, internet account to expand the features. Expanded features include selective feeding (when using in conjunction with imaging devices), push notifications relative to feeder diagnostics such as “feeder jam”, “low battery”, “solar panel failure”, “low feed alert” and the ability to remotely activate the feed on demand feature, and to administer/change feed schedules via the internet from any location. Through the use of a wireless timer dispersion device with a built-in charge management system, the user can use larger solar panels capable of charging batteries vs use of low-current maintaining style panels currently in use with this industry.

The feeder level indicator leverages a sensor for measuring distance (TOF, ultrasound) and wireless connectivity technology. The device is battery operated and attaches to the feeder hopper lid. This device connects to the users mobile device and upon initial setup, the user names the device relative to the specific feeder in which it's installed and initiates an “empty read” to capture the maximum distance which indicates “empty” (user can also measure and manually input distance into the software feature). Future reads indicate the remaining level by subtracting the read value from the maximum distance (empty level). The value is presented back to the user's mobile device and allows them to connect from a distance via direct connection wireless connectivity. When the user adds this device to the DCH, the user can receive expanded features to include push notifications relative to the feed level and warnings when the feed level is low. Additionally, the DCH analysis can identify and report to the user the amount of feed dispersed over a period of time to help in budgeting and/or determining the amount of feed to bring to the location when re-filling. The feed level indicator can also be paired wirelessly to the timer device providing additional features, such as optimized feed dispersion when the feeder level decreases to user selected levels. The use of a feed level sensor (leveraging TOF, ultrasound or similar technology), collecting data relevant to a feeder hopper feed level connected to the lid and wirelessly providing data determined by an algorithm, relative to the feed level and provide estimated re-fill date to a user via wireless mobile connection. Through the use of a mobile/PC app, the user can receive notifications as reminders of when to re-fill the feeder hopper.

In an embodiment, the trail camera and data collection hub in combination include modular imaging device(s) that wirelessly connects to the data collection hub (with the ability to connect 4 imaging devices at one time). The imaging device performance/capabilities (i.e., picture quality, trigger speeds, etc.) can be updated to match the pace of the imaging device lens technology, etc. Therefore, users may only need to purchase the small imaging device as technology improves to the point they are compelled to make an upgrade. Imaging devices are forward and backward compatible to the DCH to ensure seamless transitions to the user. Imaging devices are controlled by the DCH related to all settings adjustments that are common to the trail imaging device industry (video/still, motion sensitivity, motion range, delay rate, image quality, etc.). The imaging device connection to the DCH is addressed and can be disassociated with the DCH in order to be connected to a different DCH. In the event the imaging device is moved or disabled, the DCH sends an alert that results in a push notification to assist in theft reduction. With the small form factor and low battery consumption, the imaging device can easily be concealed as well as placed in shaded areas without worry of solar charging needs. Use of a device equipped with one or multiple sensors, which includes but not limited to imaging sensors, temperature sensors, humidity sensors, wind speed sensors, distance measurement sensors and gps receivers, wirelessly connected to a locally installed (in field) data computing and storage device to capture still and video data along with proprietary metadata values of: date, time, moon phase, gps coordinates, location name, temperature, weather conditions and animal species attributes create reporting and algorithms which trigger actions/send commands to other connected devices. The actions include the ability to automatically adjust the scheduled feed dispersion times of a timer based on the natural times when animals come to the feed location as well as report and recommend optimal hunting times that are specific to that location's environment determined by the collected metadata and algorithms. The use of an imaging device connected to a data computing and storage device to identify animal species, sex, age and scoring estimates and through use of reporting and algorithms, allow the user the ability, through the use of a mobile/PC app, to define and tag certain attributes and specimens to track independently from the rest of the animals visiting the feed/observation area. The use of a imaging device connected to a data computing and storage device to identify animal species, sex, age and scoring estimates and through use of reporting and algorithms, allow the user, through the use of a mobile/PC app, the ability to define and tag certain attributes and specimens to limit or provide additional feed dispersion through a connected timer which is connected to a timed feed dispersion hopper. The use of a feed level sensor (leveraging TOF, ultrasound or similar technology), collecting data relevant to a feeder hopper feed level connected to the lid and wirelessly providing data determined by an algorithm, relative to the feed level and estimated re-fill date to a paired wireless timer dispersion device. Leveraging the data passed to the paired wireless timer dispersion device, the timer leveraging an algorithm, will incorporate user definable settings allowing the feeder to reduce/optimize feed durations thereby prolonging the time a user has to re-fill a feeder hopper if the feed level becomes low. Through the use of a mobile/PC app, the user will receive notifications as reminders of when to re-fill their feeder hopper. Through the use of a wireless timer dispersion device and a mobile/PC app, users can connect wirelessly to the timer dispersion device to remotely adjust feed schedules, remotely disperse feed, check on the feeder function, including feed level when paired to the feed level sensor. Additionally, the user can check on the battery voltage charge level and solar panel function to ensure equipment is operating properly without having to physically be present at the feeder. Furthermore, the user may receive notifications via mobile app/PC in the event of operating failures that may occur.

In an embodiment, the present system enables the use of a device equipped with one or multiple sensors, which includes but is not limited to imaging sensors, temperature sensors, humidity sensors, wind speed sensors, distance measurement sensors and gps receivers, wirelessly connected to a locally installed (in field) data computing and storage device to capture still and video data along with metadata values of: date, time, moon phase, gps coordinates, location name, temperature, weather conditions to create reporting and algorithms which trigger actions/send commands to other connected devices. The actions include the ability to automatically adjust the scheduled feed dispersion times of a timer based on the natural times when animals come to the feed location as well as report optimal hunting times that are specific to that location's environment determined by the collected metadata and algorithms. A computing device connects cameras, timer and feed level indicator together and allows the user to administer them from a direct connection or via the internet.

In an embodiment, the present system enables the use of an imaging device connected to a data computing and storage device to identify animal species, sex, age and scoring estimates and through use of reporting and algorithms, allows the user the ability, through the use of a mobile/PC app, to define and tag certain attributes and specimens to track independently from the rest of the animals visiting the feed/observation area. The system can track specific animals that are tagged by the user to pattern their movement by taking pictures and comparing to tables defining specific species attributes (using AI).

In an embodiment, the present system enables the use of an imaging device connected to a data computing and storage device to identify animal species, sex, age and scoring estimates and through use of reporting and algorithms, allow the user, through the use of a mobile/PC app, the ability to define and tag certain attributes and specimens to limit or provide additional feed dispersion through a connected timer which is connected to a timed feed dispersion hopper. The system can track specific animals that are tagged by the user to selectively feed or not feed when the tagged animal is present at the feeder by taking pictures and comparing to tables defining specific species attributes (using AI).

In an embodiment, the present system enables the use of a proprietary feed level sensor (leveraging TOF, ultrasound or similar technology), collecting data relevant to a feeder hopper feed level connected to the lid and wirelessly providing data determined by an algorithm, relative to the feed level and estimated re-fill date to a user via wireless mobile connection. Through the use of a mobile/PC app, the user can receive notifications as reminders of when to re-fill their feeder hopper. The feed level indicator can display to the user the remaining level of feed in the hopper and estimate the refill date based on consumption.

In an embodiment, the present system enables the use of a feed level sensor (leveraging Tof, ultrasound or similar technology), collecting data relevant to a feeder hopper feed level connected to the lid and wirelessly providing data determined by an algorithm, relative to the feed level and estimated re-fill date to a paired wireless timer dispersion device. Leveraging the data passed to the paired wireless timer dispersion device, the timer leveraging an algorithm, will incorporate user definable settings allowing the feeder to reduce/optimize feed durations thereby prolonging the time a user has to re-fill a feeder hopper if the feed level becomes low. Through the use of a mobile/PC app, the user can receive notifications as reminders of when to re-fill their feeder hopper. When connected to the timer, can reduce the amount of feed depending upon how low the hopper becomes in an attempt to extend the time the user has to fill while at the same time keep animals coming to the feed location.

In an embodiment, the present system enables, through the use of a wireless timer dispersion device and a mobile/PC app, users to connect wirelessly to the timer dispersion device to remotely adjust feed schedules, remotely disperse feed, check on the feeder function, including feed level when paired to the feed level sensor. Additionally, the user can check on the battery voltage charge level and solar panel function to ensure equipment is operating properly without having to physically be present at the feeder. Furthermore, the user may receive notifications via mobile app/PC in the event of operating failures that may occur. The user can connect via the internet and check and administer their timer.

In an embodiment, the present system enables, through the use of a proprietary wireless timer dispersion device with a built-in charge management system, the use of larger solar panels capable of charging batteries vs use of low-current maintaining style panels currently in use with this industry. The user can use a bigger solar panel than one that provides only enough current to keep a trickle charge.

In an embodiment, the present system enables each device, including feed level sensor, timer and imaging sensor with data hub to operate independent of one another and be paired and connected to expand the features noted above. Devices use wireless connections, such as but not limited to Bluetooth Long Range (BLE 5), Long Range WiFi, Cellular and Satellite. Devices including timer, feed level indicator and camera can all work as single devices or be combined together.

In an embodiment, the software component includes an app for use with mobile devices and PCs as well as an internet/cloud based service allowing the user to send data collected and stored on the local data collection hubs, administer all connected hunting devices registered to the user and report on one or many hunting locations through algorithms and reporting features, such as but not limited to: operating efficiencies, feeders needing maintenance, feeders needing filled, animal movement, animal profiles, animal pictures and videos. In addition to being able to connect all devices, when connected, the user can access and administer via internet.

In an embodiment, the imaging device connected to the mobile device application software provides the user with the ability to split the video screen of a mobile device using the front or rear facing imaging device of the mobile device in conjunction with the imaging devices and record/live stream a split-screen video for use in self-assessment of shooting discipline or shooter error, playback of a hunt to determine direction of animal to track, creating recreational videos, streaming live via social media platforms, the ability to re-locate the imaging device over a target for sighting in the accuracy of a rifle and viewing both the shooter and the target in a single video.

In an embodiment, the present system enables the use of a post-harvest animal tracking device leveraging wireless connectivity and positioning and collaborative input to create and store a blood trailing map to aid hunters in recovery of a wounded animal. The mobile application provides multiple users the ability to join a collaborative recovery event and drop location identifiers when blood drops are identified. The location identifiers connect the blood drops identified and create a visible blood trail which displays on the screen thereby allowing the retracing of the animal's movement without having to re-identify each drop of blood.

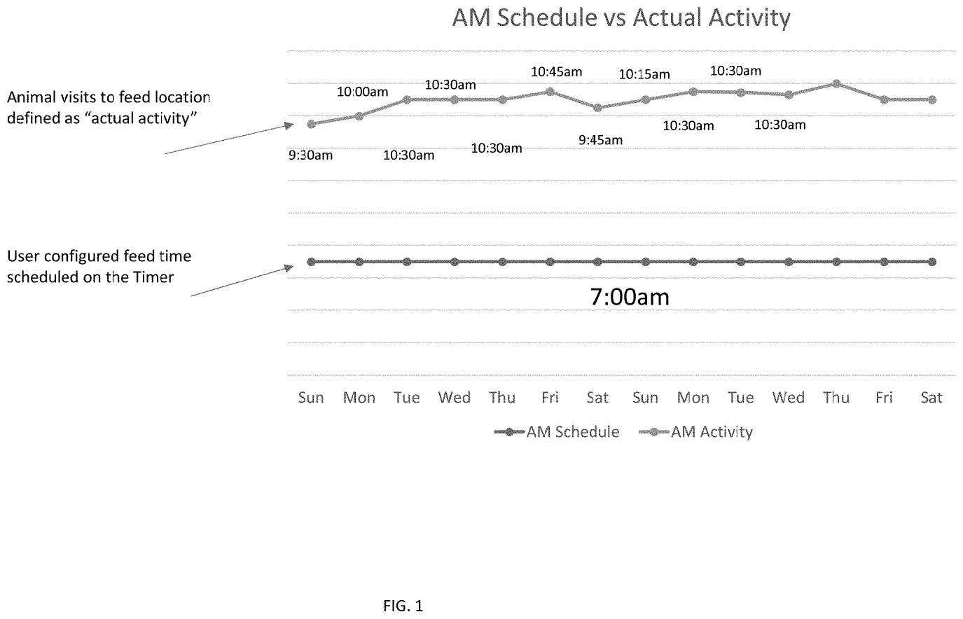

FIG. 1 shows a dynamic report of the scheduled feed times saved to the feeder timer defined by the user vs the actual times when animal activity took place in the past 2 weeks. The DCH collects the user configured feed schedule from the connected timer and captures the day and time of animal visits as captured by the imaging devices installed at the feeder and connected to the DCH. The report displays as a line, the constant feed schedule (the user defined feed disbursal times) and a line reflecting when the animals actually visit the feed location. With this information the user gains a better understanding on when animals are actually making visits and can adjust their hunting duration to ensure they are in the hunting location at the times when the animals have been consistently showing up. As the example, the timer device is configured to feed at 7 AM each day. The animal visits to the feed location are later in the morning between the hours of 9:30 and 10:45 AM respectively. It is possible that the user was not staying in the hunting location long enough to successfully harvest and animal because they may have decided after 9:00 AM to discontinue hunting in that location. With this reporting information, they can now easily see that if they stay in the hunting location until 11:00 AM, they will have a much higher probability of seeing and harvesting an animal. The report is dynamic and it refreshes each day to reflect the last 14 days thereby allowing the user to review the report prior to hunting to better understand what time to hunt the location. The user can then use this report data to determine if they are feeding at the right times, should adjust their feed times and if they are staying in the field long enough.

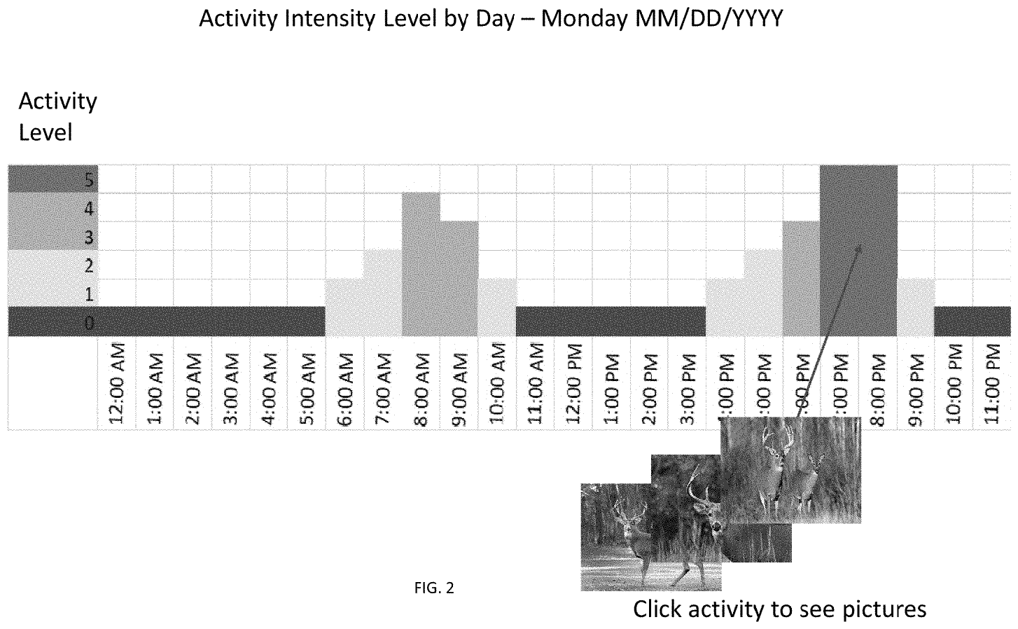

FIG. 2 shows a dynamic report by day of animal visits and the concentration (number of animals), with color coded indications of the peak times when there is activity with Red color being no activity to Dark Green being significant activity. The use of an imaging device (camera) connected to a DCH device to identify animal species, sex, age and scoring estimates and through use of reporting and algorithms, allow the user the ability, through the use of a mobile/PC app, to define and tag certain attributes and specimens to track independently from the rest of the animals visiting the feed/observation area. By taking pictures and comparing to tables defining specific species attributes (using AI), the system can track specific animals that are tagged by the user to pattern their movement. The user can click on the bar to quickly see images/videos of the animals present during that time. This reporting tool is helpful to determine peak animal visit times and then quickly determine the species and attributes of the animal visually by clicking on the peak times and viewing all pictures captured during that specific time. From this report, the user can easily then click and assign a name to the animal they identify as a “target” animal to track by clicking on all available pictures of the “target” animal. The DCH software will begin to identify and store visits made by that tagged animal and allow the user to continue to fine-tune the collected pictures to more narrowly focus on that animal. In other words, when the user initially sees an animal they would like to target and track separately, they click on each photo that is captured of the animal (for example, if there were 5 pictures of the animal and it's a specific whitetail deer with a very large and specific set of antlers). The user must click on all 5 pictures and then assign a name to the deer (for example “10 pt shooter whitetail”). The DCH will continue to capture all visits to the feed location and report activity of ALL animals and additionally, present the user with a report of only “tagged” animal visits. The user can then browse both ALL and “tagged” to look for additional pictures of the “tagged” animal (in the case 10 pt shooter whitetail), in an attempt to add more pictures at different angles and distances making the accuracy of the report increase in effectiveness. Typically, the user would begin this process prior to the beginning of the hunting season to have a pre-determined target animal that represents the desirable attributes of the user.

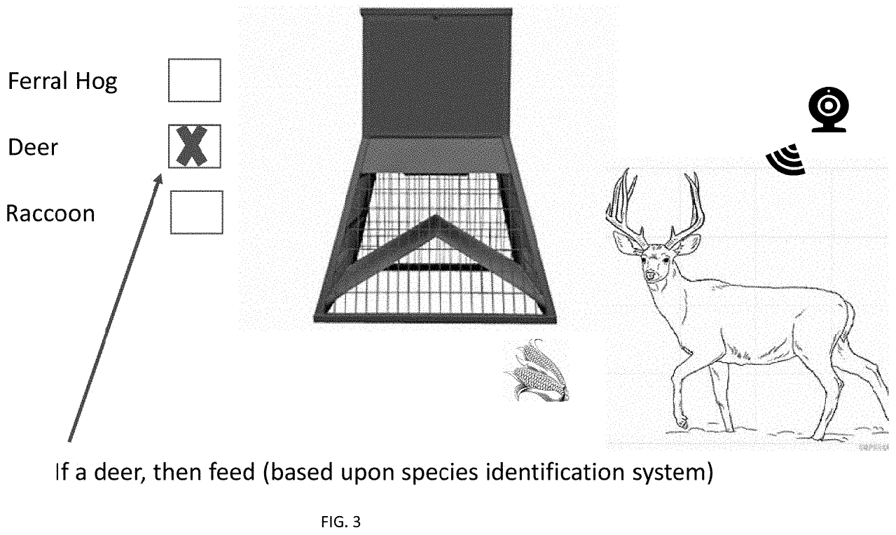

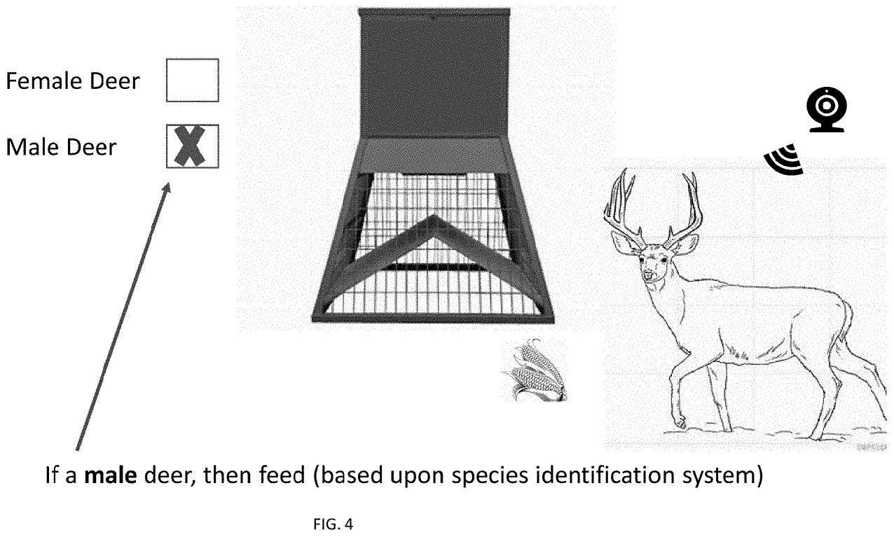

The use of an imaging device connected to a data computing and storage device can identify animal species, sex, age and scoring estimates and through use of reporting and algorithms, allow the user, through the use of a mobile/PC app, the ability to define and tag certain attributes and specimens to limit or provide additional feed dispersion through a connected timer which is connected to a timed feed dispersion hopper. By taking pictures and comparing to tables defining specific species attributes (using AI), the system can track specific animals that are tagged by the user to selectively feed or not feed when the tagged animal is present at the feeder. FIGS. 3 and 4 show an example of how we use species identification to selectively feed or not feed certain species, sexes of species and tagged animals, as described in FIG. 2. Using the DCH connected to a feeder timer, and imaging devices, the user can review pictures of animals visiting the feeder based on user configured feed times. Once the feeder has been in place for a duration of time (determined by the user, but typically after 3-4 months of use), the user can browse the pictures and selectively identify all species of animals they would like not to feed when they visit the location. The user can then configure the timer to only feed when animals visit that are not identified as “do not feed” species. As the data collection increases, the user can continue to click on images of “do not feed” species, improving the identification performance as data collection increases. Additionally, the user can configure more granular species attributes if they chose to not feed certain sexes or undesirable attributes. As an example, the feeder timer can be configured to only feed male whitetail deer when they visit the feed location by recognition of their body attributes (antlers, anatomical build, etc). The example in FIGS. 3 and 4 reflect the selection of only feeding deer in FIG. 3 and then more specifically, in FIG. 4 only feeding male deer. This reporting tool is valuable in providing the user with the data to optimize the feeding program and to reduce wasted feed where the user would normally just feed any species that comes to the feed location during the programed feed times.

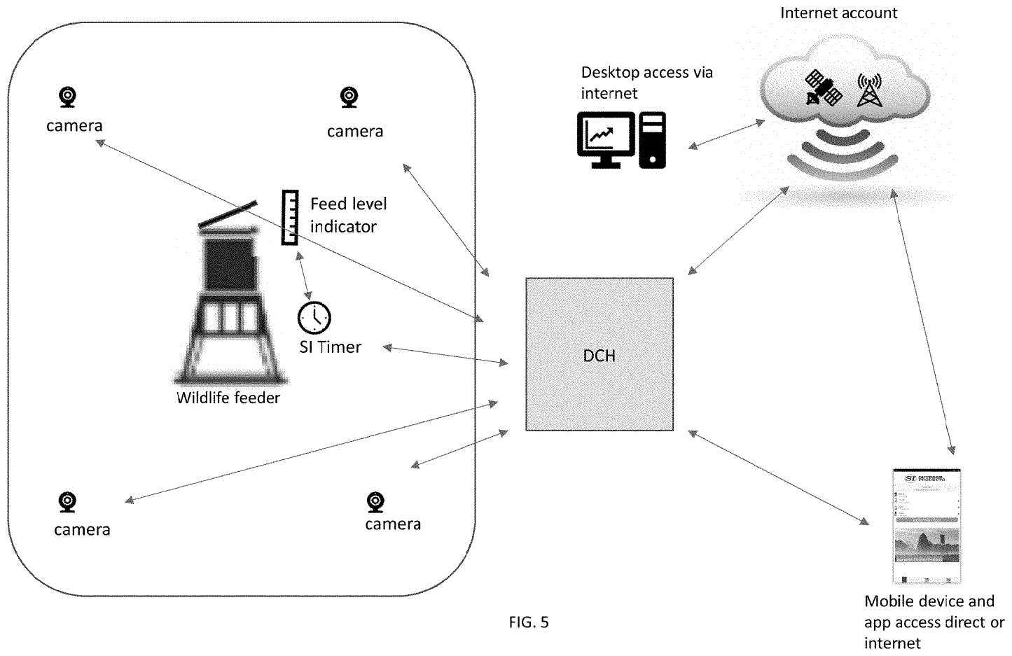

FIG. 5 is an illustration of the various key components that are connected and accessible via mobile device as well as a cellular/satellite connected internet solution. The key components illustrated are Image devices/cameras, Feed Level Indicator, Timer, DCH (Data Collection Hub). Each DCH is capable of pairing up to 4 imaging devices (cameras), 1 timer device and one FLI. The DCH incorporates a battery, a circuit board with a wireless module (a suitable design incorporates BLE5 as well as wifi), a cellular module (a suitable design incorporates a 4G wireless communication module), a gps module, as well as wind, temperature sensors, a microprocessor and data storage memory (a suitable design incorporates a solid state hard drive). The DCH is placed locally in the hunting area close to the wildlife feeder (within 100 m of the wildlife feeder). The DCH pairs up to 4 imaging devices wirelessly to communicate image data from various angles of the wildlife feeder. The DCH pairs the feeder timer to collect data from the feeder timer relative to the feed schedule, feeder battery voltage, solar charging function, feeder function (to determine if it is working properly), Feed level in the feeder hopper as collected and reported from the FLI to the feeder timer. Additionally, the user can configure the feeder timer through the connection to the DCH, such as update of feed schedule, demand feed and changing of feed optimization settings if the feeder hopper drops below 50% or 25% full (based on data reported from the FLI to the feeder timer). The DCH is the in-field server, connecting all the devices to allow them to work more intelligently based on collected data and additionally, the DCH can be connected via cellular communication to a cloud-based internet service to provide users the ability to access, view and administer field changes from their mobile device or a desktop from any internet accessible location. Mobile devices can be used to directly access the DCH in the field or can be used to access the account via the internet.

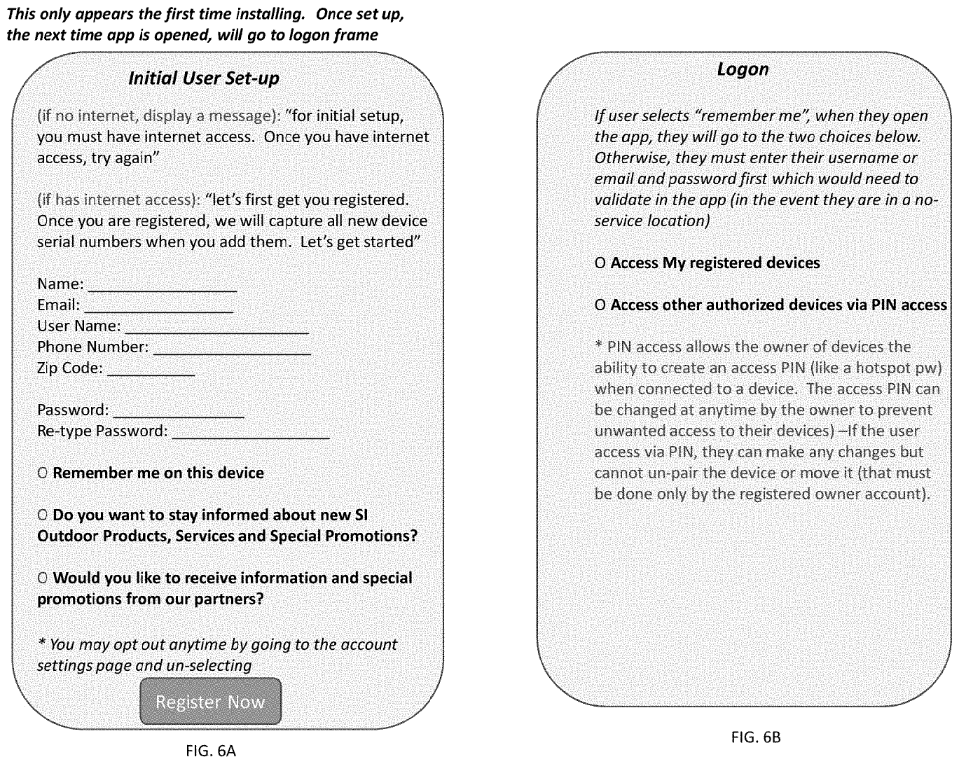

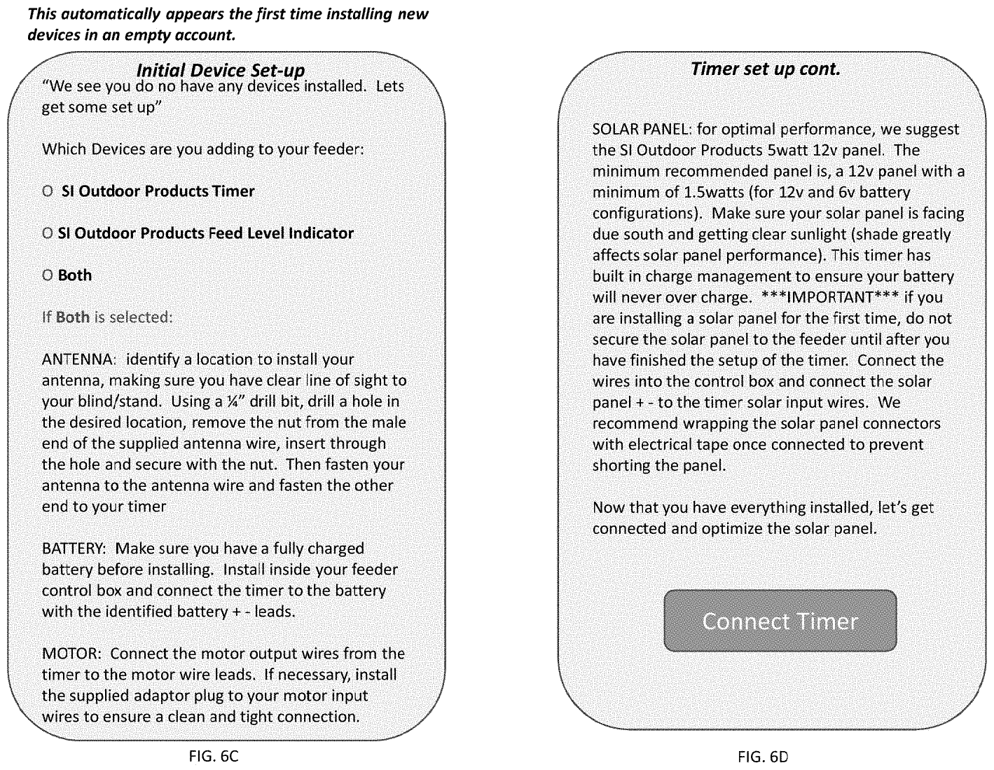

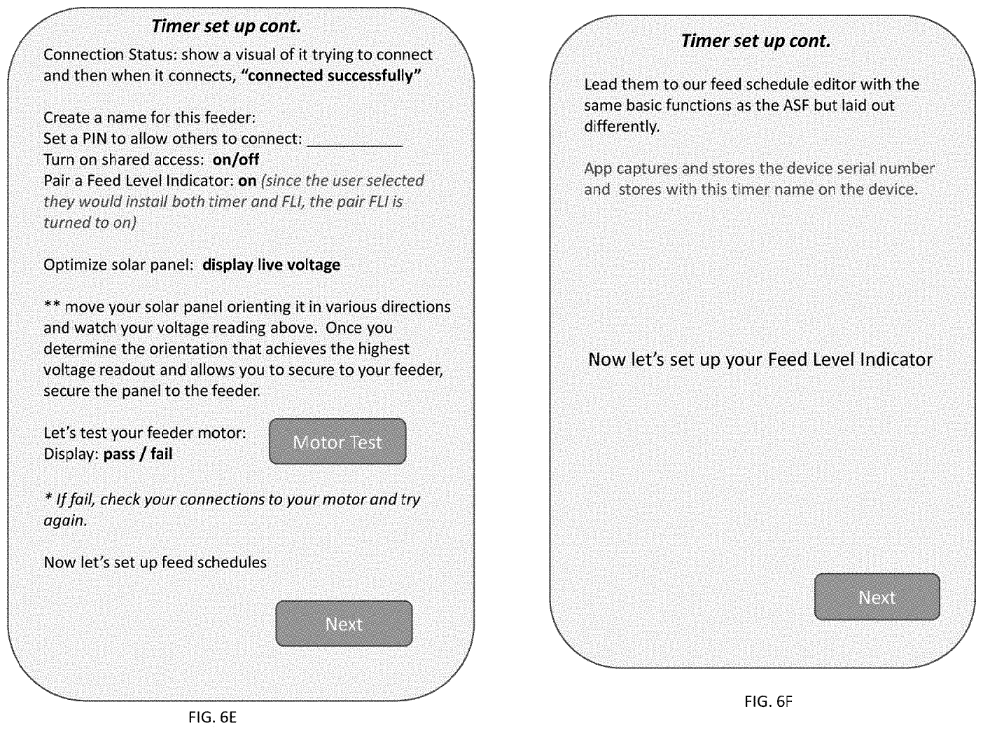

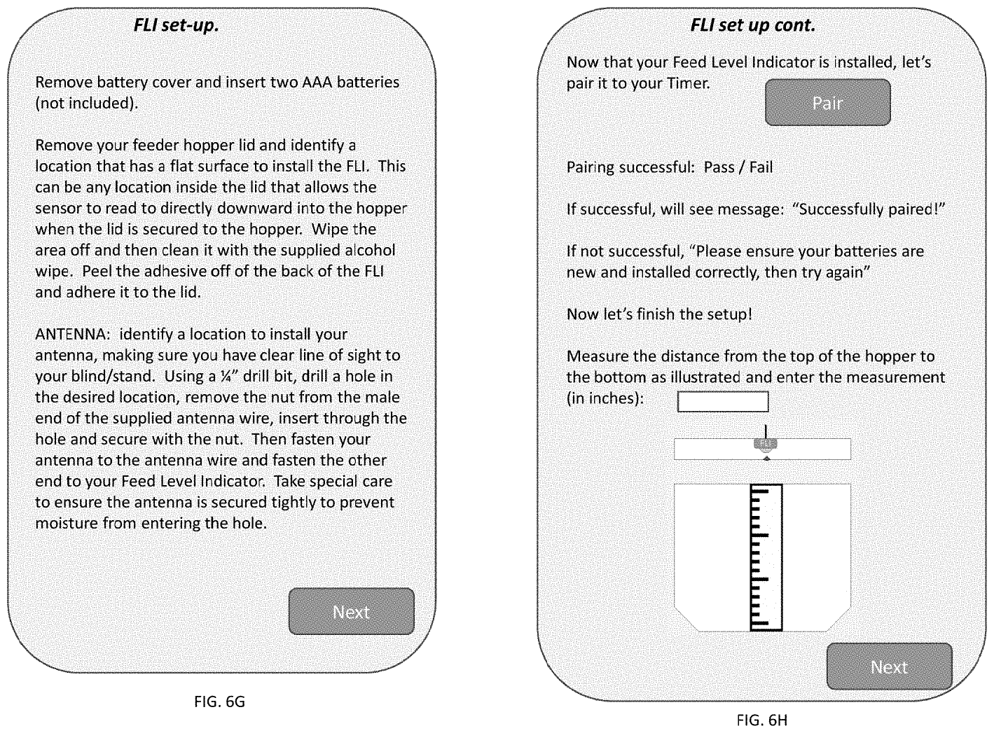

FIGS. 6A through 6I are examples of initial screens that the user is presented when installing a new timer and FLI device. Each page directs the user through an interview style process to ensure a clean and simple installation of the product. Once the initial installation is complete, the user will only see these screens, or a subset of the screens, if they administer changes to the existing installation (via the settings screen in the mobile application). Initial product installation instructions and process is performed via a mobile device application. All setup and administration of the devices is exclusively managed via wireless communication, either via mobile device connecting directly in the field or via DCH and administered through the DCH via local field connection or the internet if the user choses to connect the DCH to a cloud account and cellular subscription.

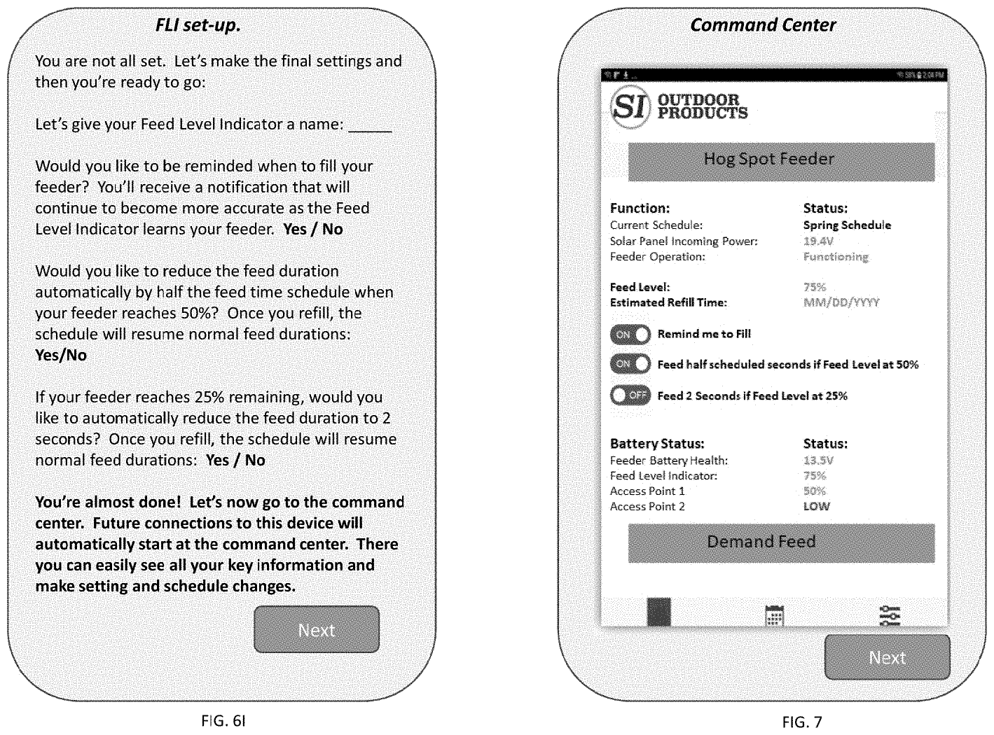

FIG. 7 shows a main screen that the user is presented when connecting in the field to the Timer directly (with or without a connected FLI). This displays the health and diagnostic data and settings for the feeder Timer and Feed Level Indicator and allows them to further navigate into the settings for administration of changes to the connected devices. This example assumes the user only has one Timer and FLI connected and 2 APRX devices. The screen shows the user defined name of the feeder/timer, the function status of what schedule is currently loaded to the device, the solar panel function to determine if the solar panel is charging properly as reflected in live input current voltage, the feeder function/operation defined as if the feeder properly disbursed feed on the last scheduled feed time. This is determined by a dramatic increase in current and assumes a dramatic increase in current is caused by a jam which prevents the feeder motor from turning properly. If the current were higher than normal, the application will display “jam” along with a message to the user to check for potential jam. The feed level is reflected as a percentage of full (similar to a fuel gage), in increments of 100%, 75%, 50%, 25%, empty. The estimated refill date is calculated based on the duration of time between refills and then mathematically determined in the future. As a simple example, if the feeder is refilled to 100% from 50% and it took 20 days from the last time filled to 100% to reach 50%, the FLI will calculate that the estimated refill date would be the current date +30 days (when the feeder hopper should be at approximately 25% full). This is used as a tool to remind users when to fill their feeder. The “remind me to fill” setting, if in the ON position sets a reminder in the mobile app and then sends a reminder notification to the user on their mobile phone. This reminder will continue each day until the feeder is refilled or the user turns off the setting. The setting “Feed half scheduled seconds if feed level at 50%” allows the user to turn on a feature to have a FLI paired to their Timer to reduce the scheduled feed times to half of their scheduled seconds if the feed level in the feed hopper drops to 50% until the feeder hopper is refilled. Once the feeder hopper is refilled above 50%, the feeder timer will revert to the timer scheduled feed durations as configured on the timer by the user. This setting allows the conservation of feed to extend the amount of time the user has to refill the feeder hopper yet still deliver feed at the same scheduled times to keep animals coming to the feed location. The setting “Feed 2 seconds if feed level is 25%”, is a second level of feed optimization related to extending the time the user has to fill their feeder. If this setting is turned on, when the feeder hopper drops to 25% full, the scheduled feed times will decrease to 2 seconds duration until the feeder is refilled. Once the feeder hopper is refilled above 50%, the feeder timer will revert to the timer scheduled feed durations as configured on the timer by the user. When the user only refills to 50%, the feeder will continue to feed based on half the scheduled feed times. The battery status displays the battery status for all connected devices. In this example, the feeder battery is reflected in green color and at 13.5 v, which indicates it is in good charged condition. The FLI has its own battery and it is reflecting 75% battery life and reflected in green indicating it is in good charged condition. The first APRX is at 50% charge life and at 50%, the color changes to yellow indicating that this will soon need changing. The second APRX is indicating a “LOW” message and reflected in red to indicate it needs changed. The “Demand Feed” button allows the user to press this button and hold to disburse feed so long as they hold the button.

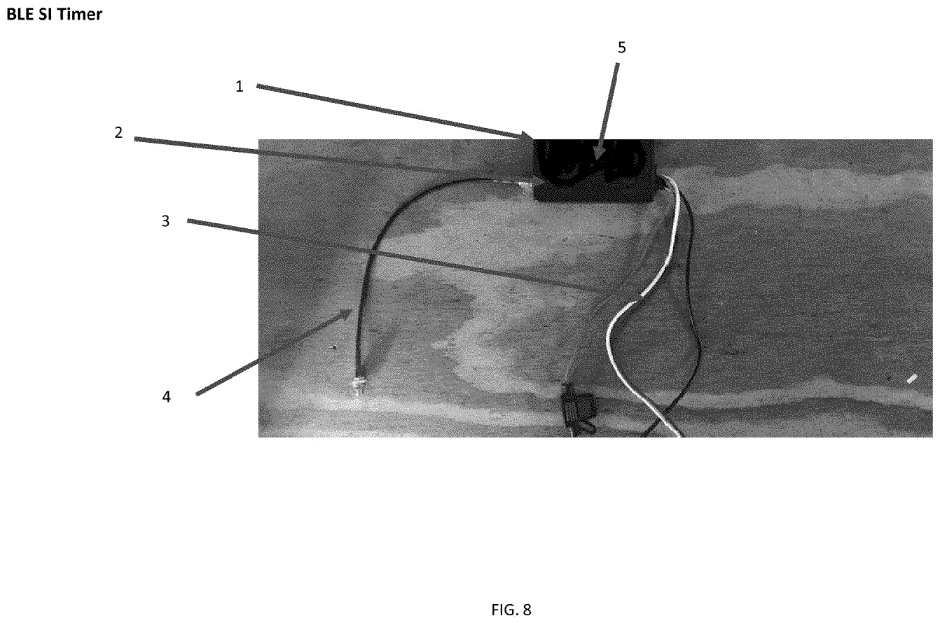

FIG. 8 reflects an illustration of the Timer enclosure including the various connection points including the antenna wire which is designed to be replaced in the event of damage, the 2 lead wires that connect to the feeder battery and the 2 lead wires that connect to the solar panel. The enclosure incorporates a reset button and a port allowing the user to reset as well as the ability to administer firmware/software updates to the board. In FIG. 8 small thin square corner design 1 made of ABS is shown with no display screen or buttons 2. Battery, solar and motor output wires 3 come outside as displayed. Regarding replaceable antenna output wire 4, user can drill small ¼″ hole and install the antenna output through the control box and secure it in place with the small nut as displayed, then screw external antenna onto extension reset button and a port to allow for upgrading board not visible but also exist on product. Timer device enclosure 5 with ABS, is shown black in color with silkscreen of product name, etc.

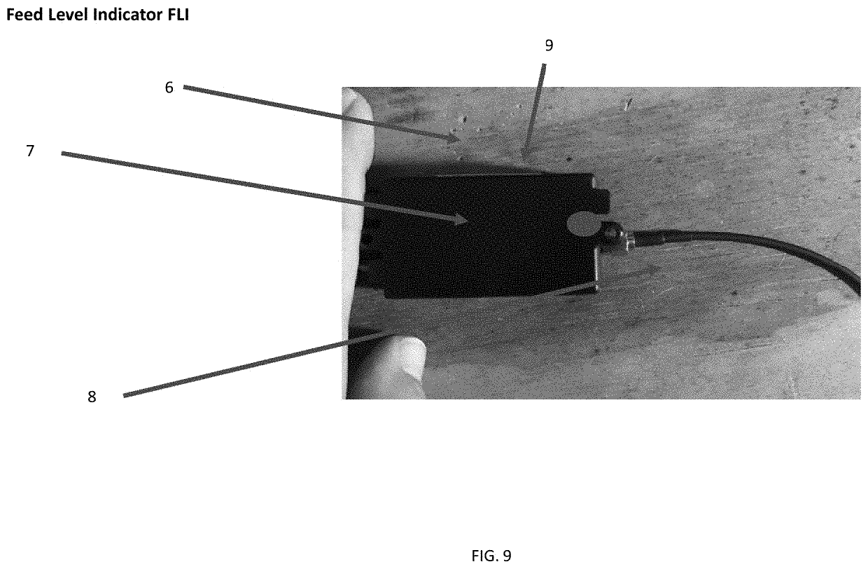

FIG. 9 is an illustration of the FLI enclosure identifying the measuring lens sensor and the antenna output wire which is designed to be replaced in the event of damage. The enclosure incorporates an opening to replace the batteries (a suitable design incorporates 2 AAA batteries) and it incorporates a reset button and port allowing the user to reset as well as the ability to administer firmware/software updates to the board. In FIG. 9 small thin square corner design 6 made of ABS is shown with sensor eye 7 centered. Regarding replaceable antenna output wire 8, user can drill small ¼″ hole and install the antenna output through the control box and secure it in place with the small nut as displayed, then screw external antenna onto extension reset button and a port to allow for upgrading board not visible but also exist on product. FLI device enclosure 9 with ABS is shown black in color with silkscreen of product name, etc.

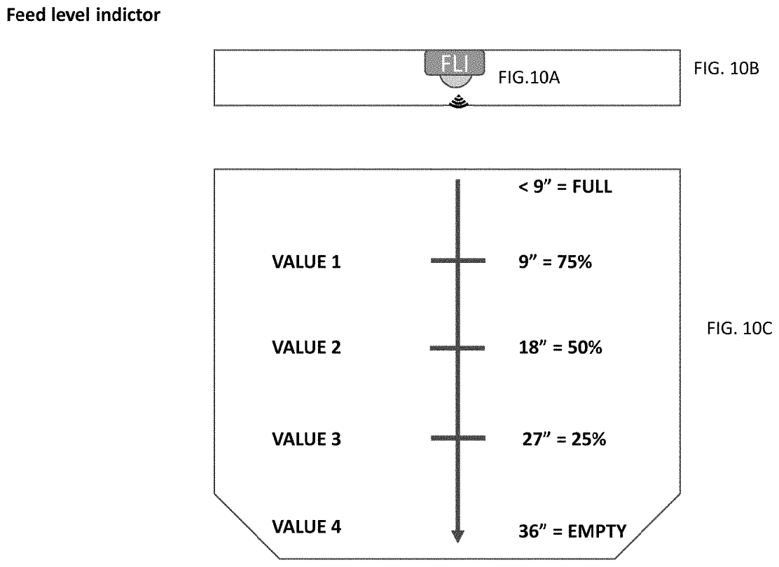

FIGS. 10A-10C illustrate a methodology for how the FLI intelligence works and an example of how it may be installed. FIG. 10A is the FLI device, FIG. 10B is the feeder hopper lid and FIG. 10C is the feeder hopper. In an embodiment, the system includes a feed level indicator incorporating wireless connection technology, a sensor for measuring liner distance, a battery and software and intelligence to read and capture the depth as a liner measurement and divide it into 4 segments. This example assumes the depth of the Hopper to be 36″. The FLI would make an empty read to establish the depth of the hopper and then save the value as the max value. Then, the FLI would divide the max value by 4 and save the values (smallest to largest). In this example VALUE 1=9, VALUE 2=18, VALUE 3=27 and VALUE 4=36. The logic to display the FEED LEVEL would be: If READ is <VALUE 1, “FULL” otherwise, if READ is >=VALUE 1 and <VALUE 2, “75%” otherwise, if READ is >=VALUE 2 and <VALUE 3, “50%” otherwise, if READ >=VALUE 3 and <VALUE 4, “25%” otherwise, EMPTY. This data is then passed to the user if they connect wirelessly directly to the FLI or if the FLI is paired to the Timer, the timer will initiate a read from the FLI following each scheduled timed feed and update a data field stored on the timer. Should the feed level be <=50% and the user has the “feed optimizer selection 1” turned ON, the Timer will perform a mathematical calculation of dividing the scheduled feed duration divided by 2. As an example, if the user has configured their timer to feed at 7 AM for 8 seconds and again at 7 PM for 8 seconds, if the FLI data reflects a value of 50%, the timer software will reduce the feed times to 7 AM for 4 seconds and 7 PM for 4 seconds. Should the feed level be <=25% and the user has the “feed optimizer selection 2” turned ON, the Timer will automatically reduce all scheduled feeds to 2 seconds. Once the user refills the feeder hopper, the timer will update to reflect the level of feed added and resume the scheduled feed durations configured by the user so long as the user filled the feed hopper more than 50%. As an example, if the user did not have enough feed to completely fill the feeder hopper but placed more than value 2 (as defined above) but less than value 1 (as defined above), the FLI value will now reflect 75%. Furthermore, the FLI, connected to the mobile app or cloud system (through connection to the DCH), captures the current date and performs a calculation based on historical data to display the estimated refill date. The application also incorporates a notification in which, if the user has the “remind me to fill” selection turn ON, the user will receive reminders as the refill date approaches of the need to refill the feeder hopper. The reminders are presented as push notifications to the user. The novel aspects of this claim include the wireless design, combined use of software technology and the method of determining the feed level as well as the ability to connect and use this information to dynamically reduce the feed durations based on information decision criteria.

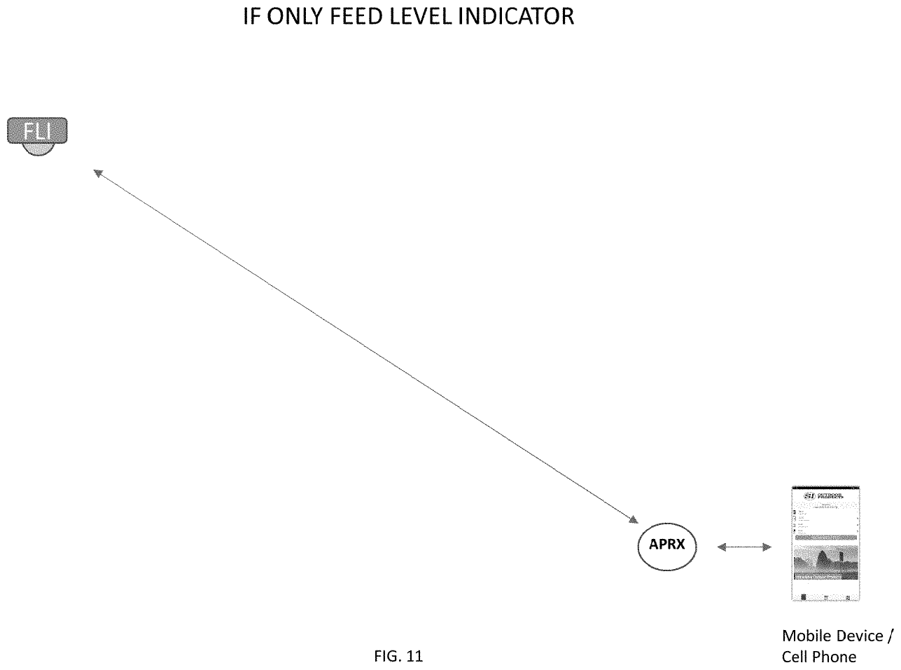

FIG. 11 illustrates a connection diagram when installing only an FLI along with an APRX device. In this case, the FLI is installed in the feeder hopper and configured to identify the name and depth of the feeder hopper. A APRX is configured as an access point to pair to the FLI providing a predictable connection range quality across any mobile device utilizing BLE.

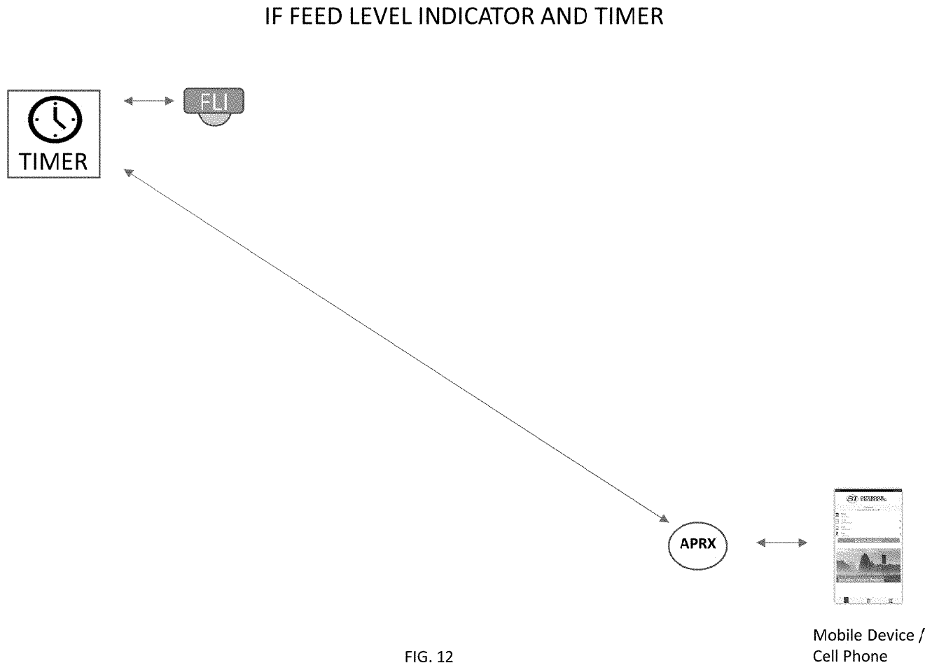

FIG. 12 illustrates a connection diagram when installing a feeder timer and FLI along with an APRX device. In this case, the user pairs the FLI to the feeder timer via BLE. The timer receives data from the FLI and stores in the Timer device including the hopper feed level. The feeder timer is then paired to an APRX configured to use as an access point to provide a predictable connection range quality across any mobile device utilizing BLE.

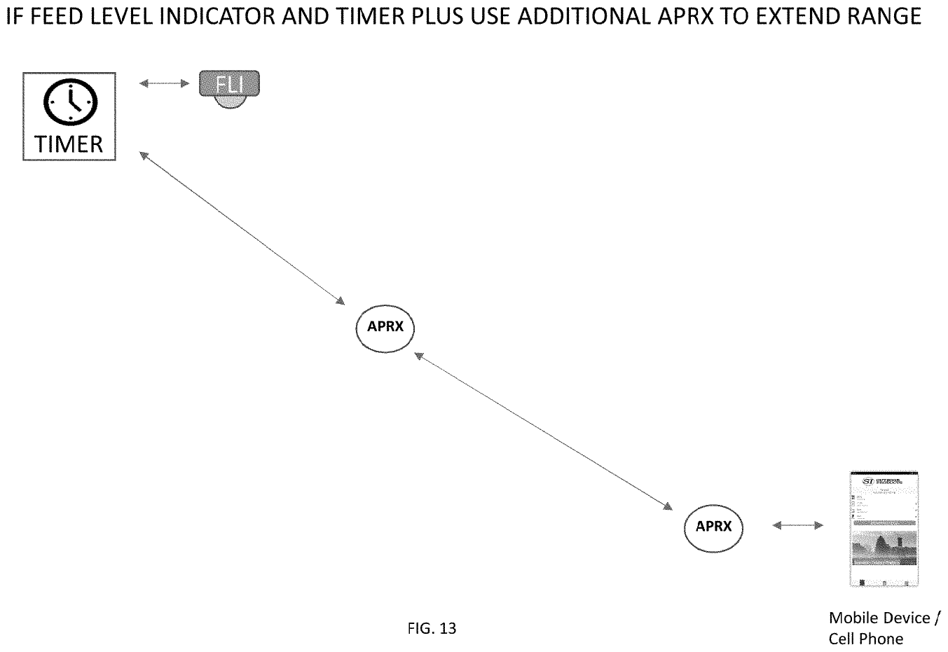

FIG. 13 illustrates a connection diagram when installing a feeder timer and FLI along with one APRX configured as a range extender and one APRX device configured as an access point. In this case, the user pairs the FLI to the feeder timer via BLE. The timer receives data from the FLI and stores in the Timer device including the hopper feed level. The feeder timer is then paired to one APRX which acts as a range extender allowing the user to increase the range of connection by up to 800 m and configures the second APRX configured to use as an access point to provide a predictable connection range quality across any mobile device utilizing BLE.

FIG. 14 illustrates an example of creating a network in the field. In this example, a user may have a 300 acre hunting location with many different feeder locations for hunting (such as 5 feeders). The user can set up each feeder with a FLI and feeder timer and then leverage multiple APRX devices to connect each of the 5 feeders into one network. Once all are connected, the user can selectively connect to all of the 5 devices from any of the APRX connection points that are paired providing a significant range of connectivity.

Both BLE Timer and FLI can be connected to mobile phone directly. Each Timer and FLI can be connected to one or multiple APRXs. APRXs can be linked together.

The connections between Timer and APRXs, FLI and APRXs, or among APRXs may use BLE long-range mode (coded PHY) to achieve >400 m range with 0 dB TX power. All BLE devices should have options to change TX power.

Both BLE Timer and FLI can be connected to mobile phone through one or multiple APRXs. When Timer and FLI are paired together Timer becomes central and FLI is peripheral. Only Timer can be connected to other BLE devices (red connections).

Mobile phone user when in range of network, whether inside network (green connection) or through multiple APRXs (bottom right), shall see all of the Timers in the network available to connect, e.g., a total of 5.

Mobile phone user when connected to an APRX, which is not inside the network (top-left purple connection), shall only see the device it connected to.

Push notification from all BLE devices is sent to mobile phone, including battery status and/or other application specific information. Example push notifications include “Timer #1 is at 25% feed level, remember to fill”, and “Timer #2 is reporting a low battery in the paired FLI”, and “Timer #4 is reporting a jam”, and “Timer #5 is reporting a low battery” and “APRX #8 is reporting 25% battery, please change soon”.

Network configuration with app. If the user creates a scatter-network, all available connections are presented on the app command center screen when in range allowing the user to change settings (access point vs range extender), and check the battery level and signal strength on one list.

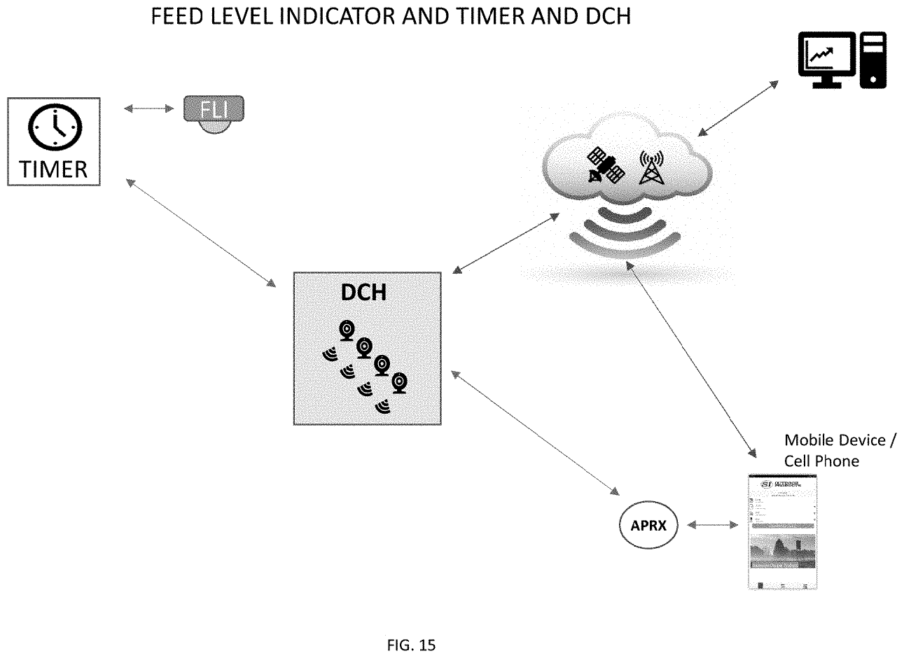

FIG. 15 is an illustration of an embodiment of various key components that are connected and accessible via mobile device as well as a cellular/satellite connected internet solution. The key components illustrated are Image devices/cameras, Feed Level Indicator, Timer, DCH (Data Collection Hub). Each DCH is capable of pairing up to 4 imaging devices (cameras), 1 timer device and one FLI. The DCH incorporates a battery, a circuit board with a wireless module (suitable designs include BLES as well as wifi), a cellular module (suitable designs include, a 4G wireless communication module), a gps module, as well as wind, temperature sensors, a microprocessor and data storage memory (a suitable design incorporates a solid state hard drive). The DCH is placed locally in the hunting area close to the wildlife feeder (within 100 m of the wildlife feeder). The DCH pairs up to 4 imaging devices wirelessly to communicate image data from various angles of the wildlife feeder. The DCH pairs the feeder timer to collect data from the feeder timer relative to the feed schedule, feeder battery voltage, solar charging function, feeder function (whether it is working properly), Feed level in the feeder hopper as collected and reported from the FLI to the feeder timer. Additionally, the user can configure the feeder timer through the connection to the DCH such as update of feed schedule, demand feed and changing of feed optimization settings if the feeder hopper drops below 50% or 25% full (based on data reported from the FLI to the feeder timer). The DCH is the in-field server, connecting all the devices to allow them to work more intelligently based on collected data and additionally, the DCH can be connected via cellular communication to a cloud-based internet service to provide users the ability to access, view and administer field changes from their mobile device or a desktop from any internet accessible location. Mobile devices can be used to directly access the DCH in the field or can be used to access the account via the internet. The Data Collection Hub (DCH) collects and serves data locally from connected devices shown and up to 4 imaging device/cameras. Additionally, can connect via cellular/satellite to update cloud-based data portal and receive user updates from internet portal relative to device setting changes and live viewing.

The wireless TIMER is connected to a feeder and paired to the DCH via wireless connection. The Feed Level Indicator (FLI) wirelessly connects, collects hopper feed level and passes feed level to TIMER. The Access Point/Range Extender (APRX) can be switched to Access Point mode allowing it to be the access point for a mobile device to connect to the DCH. Can change setting to Range Extender to extend the range between DCH and next APRX. Internet based site serving data collected to include images, videos, feed level, timer schedule, feeder battery voltage level, solar function status, feeder function status, device battery levels of all connected devices, activity reports of animal activity, analysis reports displaying animal visit times vs scheduled feed times. The mobile phone with installed user application allowing user to directly connect in the field via BLE5 or to connect from any location via connection to the internet site serving the above mentioned elements. From a PC device that has access to the internet, the user can view and administer devices connected to the account.

An embodiment of the device incorporates a wireless timer leveraging wireless connection technology, a microchip with software and firmware, and antenna. The device connects to a feeder battery and feeder motor controlling the scheduled times and durations of feed disbursed from the feeder. The aspects of the timer include through the combination of the above, include the ability to connect to a user's mobile device directly in from distances of 400 m or greater as well as to pair/connect with other devices, such as FLI and DCH. When the timer is paired with a FLI, the timer uses software calculations determined by the FLI to determine the duration in which the feeder will disburse feed. The timer software incorporates hardware and software that reads the battery voltage level and increases or decreases charge/input current to the battery captured by a solar panel when installed by the user to prevent over-charge of the battery. Additionally, the software reads the live input current of the solar panel allowing the user to optimize the orientation of the solar panel when installing to maximize the input current and charging performance. The live current is displayed through the connected mobile device to the timer which is connected directly to the solar panel. As the panel orientation is manipulated (moved in different directions and degree of angle), the screen reflects the input voltage on the user mobile device through a mobile app. The user can then install the solar panel based upon the best achievable input current orientation. Through the use of a wireless timer dispersion device and a mobile/PC app, users can connect wirelessly to the timer dispersion device to remotely adjust feed schedules, remotely disperse feed, check on the feeder function, including feed level if paired to the feed level sensor. Additionally, the user can check on the battery voltage charge level and solar panel function to ensure equipment is operating properly without having to physically be present at the feeder. Furthermore, the user may receive notifications via mobile app/PC in the event of operating failures that may occur. The user can connect via the internet and check and administer the timer. Through the use of a wireless timer dispersion device with a built-in charge management system, the user can use larger solar panels capable of charging batteries vs use of low-current maintaining style panels currently in use with this industry. The user can use a bigger solar panel than one that provides only enough current to keep a trickle charge. Each device, including feed level sensor, timer and imaging sensor with data hub can operate independent of one another and can be paired and connected to expand the features as claimed above. Devices use wireless connections, such as but not limited to Bluetooth Long Range (BLE 5), Long Range WiFi, Cellular and Satellite. The devices including timer, feed level indicator and camera can all work as single devices or be combined together. The Software component of the system includes a app for use with mobile devices and PCs as well as aninternet/cloud based service allowing the user to send data collected and stored on the local data collection hubs, administer all connected proprietary hunting devices registered to the user and report on one or many hunting locations through algorithms and reporting features such as but not limited to: operating efficiencies, feeders needing maintenance, feeders needing filled, animal movement, animal profiles, animal pictures and videos, in addition to being able to connect all devices, if connected, can access and administer via internet. Use of a device equipped with one or multiple sensors, which includes but not limited to imaging sensors, temperature sensors, humidity sensors, wind speed sensors, distance measurement sensors and gps recivers, wirelessly connected to a locally installed (in field) data computing and storage device to capture still and video data along with metadata values of: date, time, moon phase, gps coordinates, location name, temperature, weather conditions to create reporting and algorithms which trigger actions/send commands to other connected devices. The actions include the ability to automatically adjust the scheduled feed dispersion times of a timer based on the natural times when animals come to the feed location as well as report optimal hunting times that are specific to that location's environment determined by the collected metadata and algorithms. A computing device that connects cameras, timer and feed level indicator together and allows the user to administer them from a direct connection or via the internet.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A wireless wildlife observation intelligence system comprising:
a timer comprising intelligent manageability software capable of monitoring and managing battery discharge and solar panel battery charging;
a data collection hub comprising a camera and temperature sensor, wirelessly connected to the timer and at least one of a cloud based-system or user;
an antenna operatively connected to the timer;
a mobile app wirelessly connected to the antenna and capable of operation of the timer;
a solar panel operatively connected to the timer;
a rechargeable battery operatively connected to the timer;
a feed hopper comprising a feed level indicator capable of dispensing feed;
an access point range extender operatively connected to the system; and
a motor operatively connected to the timer and feed hopper.

2. The system of claim 1, wherein feed level indicator comprises a battery, antenna, wireless communication chip and a linear measuring sensor.

3. The system of claim 1, wherein the data collection hub further comprises a wind sensor.

4. The system of claim 1, wherein components of the system are modular.

5. A method for wireless wildlife observation, comprising:
providing a device equipped with one or more sensors, which comprises imaging sensors, temperature sensors, humidity sensors, wind speed sensors, distance measurement sensors and gps receivers, wirelessly connected to a locally installed in field data computing and storage device;
capturing still and video data along with metadata values of: date, time, moon phase, gps coordinates, location name, temperature, and weather conditions to create reporting and algorithms which trigger actions/send commands to other connected devices; and
performing at least one of automatically adjusting the scheduled feed dispersion times of a timer based on the natural times when animals come to the feed location as well as report optimal visit times that are specific to that location's environment determined by the collected metadata.

6. The method of claim 5, further comprising identifying animal species, sex, age and desirable attributes allowing the user the ability, through the use of a mobile/PC app, to define and tag certain attributes and specimens to track independently from the rest of the animals visiting the feed/observation area.

7. The method of claim 6, further comprising limiting or providing additional feed dispersion through a connected timer to a timed feed dispersion hopper to track specific animals that are tagged by the user to selectively feed or not feed when the tagged animal is present at the feeder.

8. The method of claim 5, wherein the device further comprises a feeder hopper having a feed level indicator and further comprising collecting data relevant to a feed level and estimated re-fill date to a user via wireless mobile connection, wherein the user receives notifications as reminders of when to re-fill the feeder hopper based on consumption.

9. The method of claim 8, wherein the device further comprises a paired wireless timer dispersion device, and further comprising incorporating user definable settings allowing the feeder to reduce/optimize feed durations thereby prolonging the time a user has to re-fill a feeder hopper when the feed level becomes low while at the same time keeping animals coming to the feed location.

10. The method of claim 5, further comprising remotely adjusting feed schedules, dispersing feed, checking on the feeder function, including feed level, battery voltage charge level and solar panel function to ensure equipment is operating properly without having to physically be present at the feeder.

11. The method of claim 5, further comprising splitting the video screen of a mobile device using the front or rear facing imaging camera and record/live stream a split-screen video for use in self-assessment of shooting discipline or shooter error, playback of a hunt to determine direction of animal to track, creating recreational videos, streaming live via social media platforms, to re-locate the imaging device over a target for sighting in the accuracy of a rifle and viewing both the shooter and the target in a single video.

12. The method of claim 5, further comprising using a post-harvest animal tracking device leveraging wireless connectivity and positioning and collaborative input to create and store a blood trailing map to aid hunters in recovery of a wounded animal by location identifiers connecting the blood drops identified and creating a visible blood trail which displays on the screen thereby allowing the retracing of the animal's movement without having to re-identify each drop of blood.
